(19) United States
(12) Patent Application Publication
(10) Pub. No.: US 2010/0013716 A1
(43) Pub. Date: Jan. 21, 2010

(54) Multi-frequency antenna and an electronic device having the multi-frequency antenna

(75) Inventors: Li-Jean Yen, Taipei Hsien (TW); Chia-Tien Li, Taipei Hsien (TW)

Correspondence Address: BACON & THOMAS, PLLC, 625 SLATERS LANE, FOURTH FLOOR, ALEXANDRIA, VA, 22314-1176, US

(73) Assignee: WISTRON NEWEB CORP., Taipei Hsien (TW)

(21) Appl. No.: 12/385,027

(22) Filed: Mar. 30, 2009

(30) Foreign Application Priority Data
Jul. 15, 2008 (TW) 097126771

(51) Int. Cl. H01Q 1/36; H01Q 1/48

(52) U.S. Cl. 343/700 MS; 343/846

(57) ABSTRACT

A multi-frequency antenna and an electronic device having the multi-frequency antenna are disclosed. The multi-frequency antenna comprises: a first radiating element including a first end and a second end; a grounding element connected to the first end of the first radiating element; a feeding structure for inputting an electrical signal to the first radiating element; and a second radiating element including a first end and a second end. The first end of the second radiating element includes a transitional portion; and the second radiating element is connected to the second end of the first radiating element by the transitional portion. So that the first radiating element forms a first current path to generate a first resonant mode; and the second radiating element forms a second current path to generate a second resonant mode.

### BACKGROUND OF THE INVENTION

1. Field of the Invention

The present invention relates to a multi-frequency antenna and an electronic device having the multi-frequency antenna, and, more particularly, to an inductively coupled multi-frequency antenna and an electronic device having the multi-frequency antenna.

2. Description of the Related Art

With wireless communication technology development, people have higher and higher demands for wireless communication. There are many electronic devices with wireless communication function such as mobile phones, GPS, PDAs, and notebook computers. Meanwhile, more and more information are transmitted via the wireless network, so the bandwidth is also increased.

Prior art technology includes many different wireless communication technologies for different operation frequencies, such as UWB, WiMAX, WiFi or 3G wireless communication technology. Therefore, in order to satisfy wireless communication at different frequencies, multi-frequency antennas have become the main trend.

However, people also prefer smaller and lighter electronic devices, and the wireless communication units need to have smaller size too.

Prior art technology discloses a planar Inverted-F antenna. Please refer to FIGS. 1A and 1B. FIG. 1A is a schematic drawing of a prior art planar Inverted-F antenna. FIG. 1B is a VSWR relationship drawing of the prior art planar Inverted-F antenna. As shown in FIG. 1A, a prior art antenna 90 has a radiating element 91, a grounding element 92 and a feeding structure 93, As shown in FIG. 1B, the antenna 90 only has one single resonant mode, which cannot provide multi-frequencies.

Therefore, it is desirable to provide a multi-frequency antenna that can provide broad bandwidth and smaller dimensions to mitigate and/or obviate the aforementioned problems.

### SUMMARY OF THE INVENTION

A main objective of the present invention is to provide a multi-frequency antenna and an electronic device having the multi-frequency antenna, which can provide broad bandwidth and smaller dimensions.

The electronic device of the invention comprises a wireless transmission module and a multi-frequency antenna, the multi-frequency antenna and the wireless transmission module are electrically connected together. The multi-frequency antenna comprises: a first radiating element including a first end and a second end; a grounding element connected to the first end of the first radiating element; a feeding structure for inputting an electrical signal to the first radiating element; and a second radiating element including a first end and a second end. The first end of the second radiating element includes a transitional portion; and the second radiating element is connected to the second end of the first radiating element by the transitional portion. So that the first radiating element forms a first current path to generate a first resonant mode; and the second radiating element forms a second current path to generate a second resonant mode.

In one embodiment of the invention, the first radiating element and the second radiating element are integrated together; the transitional portion has a substantially 90° angle, the second radiating element is connected to the second end of the first radiating element via the transitional portion and extends toward to the first end of the first radiating element, so the second radiating element is substantially parallel with the first radiating element; and a gap is formed between the first radiating element and the second radiating element.

In one embodiment of the invention, the multi-frequency antenna further has a top load, and the top load and the second end of the second radiating element are electrically connected together; wherein the top load is an inductive load. The top load is electrically connected to the second radiating element via passive component connection, circuit connection or direct connection; the shape of the top load is a loop shape, which is different from the shape of the second radiating element.

In one embodiment of the invention, the multi-frequency antenna has a base and a third radiating element. The base has a first surface and a second surface, and the first radiating element, the grounding element, the feeding structure, the second radiating element and the top load being disposed on the first surface. The third radiating element is disposed on the second surface and is electrically connected to the grounding element. The feeding structure feeds back the electrical signal to the third radiating element by capacitive coupling.

Other objects, advantages, and novel features of the invention will become more apparent from the following detailed description when taken in conjunction with the accompanying drawings.

### BRIEF DESCRIPTION OF THE DRAWINGS

FIG. 1A is a schematic drawing of a prior art antenna.

FIG. 1B is a VSWR relationship drawing of the prior art antenna.

FIG. 2A is a schematic drawing of a multi-frequency antenna in a first embodiment according to the invention.

FIG. 2B is a VSWR relationship drawing of the multi-frequency antenna in the first embodiment according to the invention.

FIG. 3A is a schematic drawing of a multi-frequency antenna in a second embodiment according to the invention.

FIG. 3B is a VSWR relationship drawing of the multi-frequency antenna in the second embodiment according to the invention.

FIG. 4A is a back view schematic drawing of a multi-frequency antenna in a third embodiment according to the invention.

FIG. 4B is a front view schematic drawing of a multi-frequency antenna in the third embodiment according to the invention.

FIG. 4C is a VSWR relationship drawing of the multi-frequency antenna in the third embodiment according to the invention.

FIG. 5 is a functional block drawing of an electronic device according to the invention.

### DETAILED DESCRIPTION OF THE PREFERRED EMBODIMENT

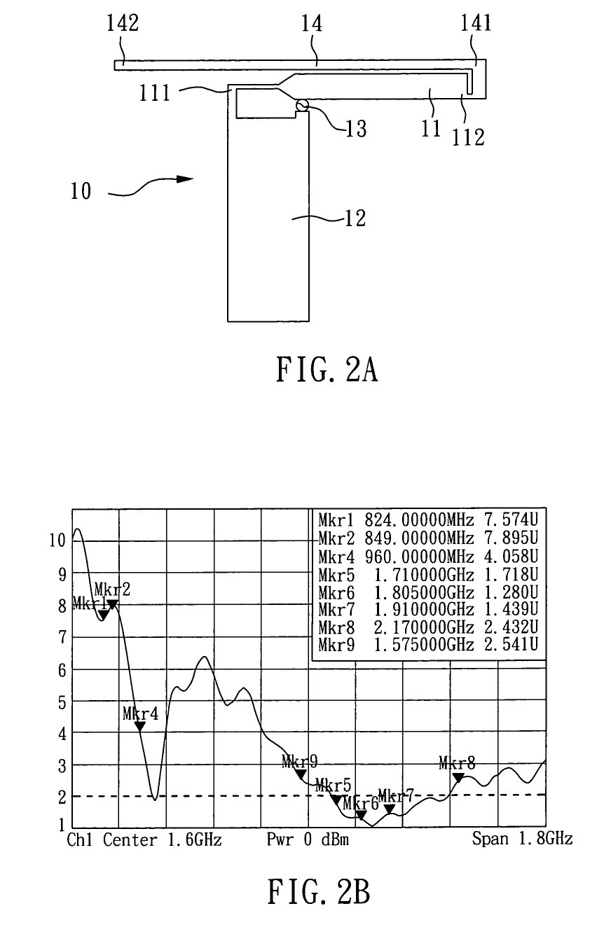

Pleases refer to FIG. 2A and FIG.2B. FIG. 2A is a schematic drawing of a multi-frequency antenna in a first embodiment according to the invention. FIG. 2B is a VSWR relationship drawing of the multi-frequency antenna in the first embodiment according to the invention.

As shown in FIG. 2A, a multi-frequency antenna 10 of the first embodiment has a first radiating element 11, a grounding element 12, a feeding structure 13 and a second radiating element 14. The first radiating element 11 has a first end 111 and a second end 112. The grounding element 12 is connected to the first end 111 of the first radiating element 11.

The feeding structure 13 has a feeding point (not shown) being electrically connected to a feeding wire (not shown), which is used for inputting electrical signals to the first radiating element 11. The feeding wire can be a RF cable or other various cables.

As shown in FIG. 2A, the second radiating element 14 has a first end 141 and a second end 142, and the first end 141 of the second radiating element 14 has a transitional portion, the second radiating element 14 is connected to the second end 112 of the first radiating element 12 via the transitional portion.

Since the second radiating element 14 is connected to the first radiating element 12 via the transitional portion, when the feeding structure 13 feeds electrical signals to the first radiating element 11, a first current path is formed on the first radiating element 11 and a second current path is formed on the second radiating element 14. Therefore, the multi-frequency antenna 10 generates two resonant modes to provide multiple frequencies. The first radiating element 11 generates the first resonant mode, and the second radiating element 14 generates the second resonant mode with a lower operation frequency than the first resonant mode.

As shown in FIG. 2A, the first radiating element 11 has a V shape, however, the radiating element with any other shape can still be the first radiating element 11. The second radiating element 14 has an L shape, but radiating element with any other shape can still be the second radiating element 14. Furthermore, the first radiating element 11 and the second radiating element 14 are integrated together. However, different shapes and lengths of the first radiating element 11 and the second radiating element 14 can change the characteristics of the antenna, and the antenna designer can change the shapes and lengths of the first radiating element 11 or the second radiating element 14 to have different operation frequencies and bandwidth of the multi-frequency antenna 10. Similarly, a gap is formed between the first radiating element 11 and the second radiating element 14, and the size of the gap can change the characteristic of the antenna.

As shown in FIG. 2A, the transitional portion of the first end 141 of the second radiating element 14 has a substantially 90° angle, and the second radiating element 14 is connected to the second end 112 of the first radiating element 11 via the transitional portion and extends toward to the first end 111 of the first radiating element 11 so the second radiating element 14 is substantially parallel with the first radiating element 11. Therefore, the multi-frequency antenna 10 can have a smaller dimension to satisfy modern design requirement. However, the transitional portion of the second radiating element 14 can be not the 90° angle, and the second radiating element 14 can be not parallel with the first radiating element 11. As long as the first radiating element 11 and the second radiating element 14 can form several current paths and several resonant modes, the multi-frequency antenna 10 is accepted.

FIG. 2B shows a VSWR relationship drawing of the multi-frequency antenna 10 at different frequencies. As shown in FIG. 2B, the multi-frequency antenna 10 at operation frequency between 1.7 GHz to 2.2 GHz generates the first resonant mode and at a lower operation frequency 0.95 GHz generates the second resonant mode.

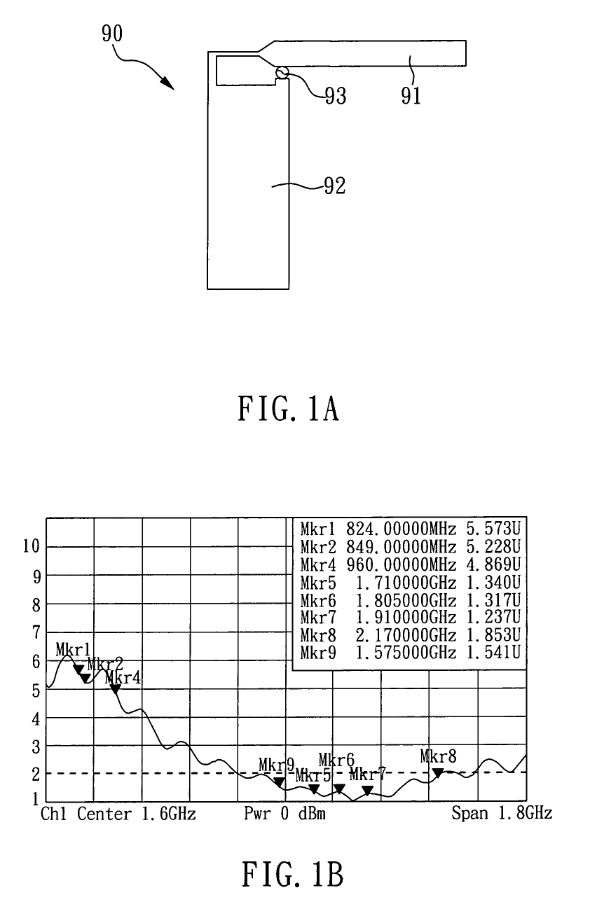

Comparing FIG. 1B with FIG. 2B, the prior art antenna 90 can only generate one single resonant mode, and the antenna 10 of the invention can generate two resonant modes and has multi-frequencies.

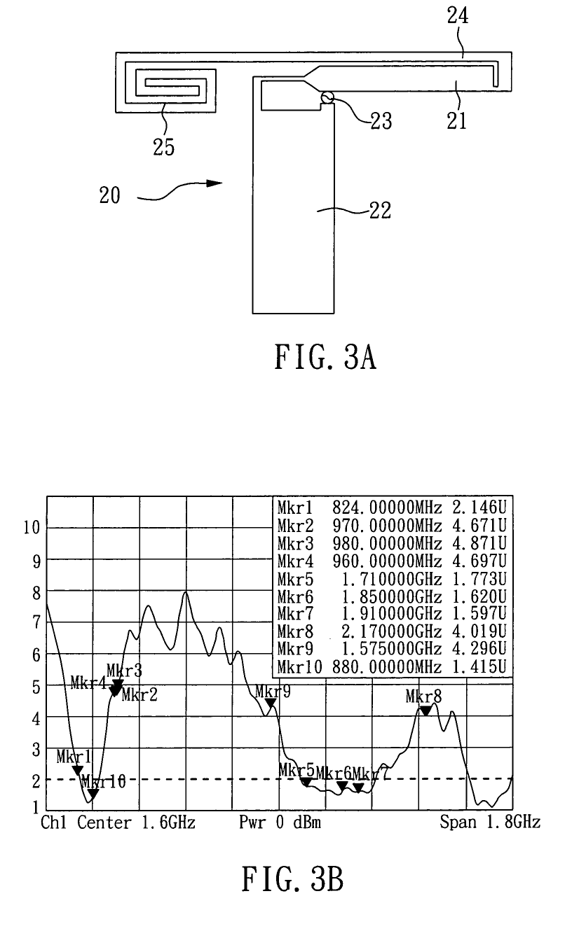

Please refer to FIG. 3A and FIG. 3B. FIG. 3A is a schematic drawing of a multi-frequency antenna in a second embodiment according to the invention. FIG. 3B is a VSWR relationship drawing of the multi-frequency antenna in the second embodiment according to the invention.

As shown in FIG. 3A, in a second embodiment, the multi-frequency antenna 20 comprises a first radiating element 21, a grounding element 22, a feeding structure 23, a second radiating element 24 and a top load 25.

The difference between the second embodiment and the first embodiment is, in the second embodiment, the multi-frequency antenna 20 comprises the top load 25 electrically connected with the second radiating element 24. With the electric reactance matching effect of the top load 25, the second resonant mode generated by the second radiating element 24 at low operation frequency can provide broad bandwidth.

As shown in FIG. 3A, the top load 25 has a loop shape, which can shorten the resonant path. However, the top load 25 just needs to have a shape different from the shape of the second radiating element 24, and the top load 25 is able to form an inductive load to change the bandwidth. Furthermore, as long as the top load 25 and the second radiating element 24 are electrically connected together, the antenna of the invention can provide multi-frequencies. For example, the top load 25 and the second radiating element 24 can be electrically connected via passive component connection, circuit connection or direct connection.

FIG. 3B shows a VSWR relationship drawing of the multi-frequency antenna 20 at different frequencies. Comparing FIG. 2B with FIG. 3B, the multi-frequency antenna 20 in the second embodiment depends on the electrical connection of the top load 25 so the second resonant mode at low frequency can provide broad bandwidth.

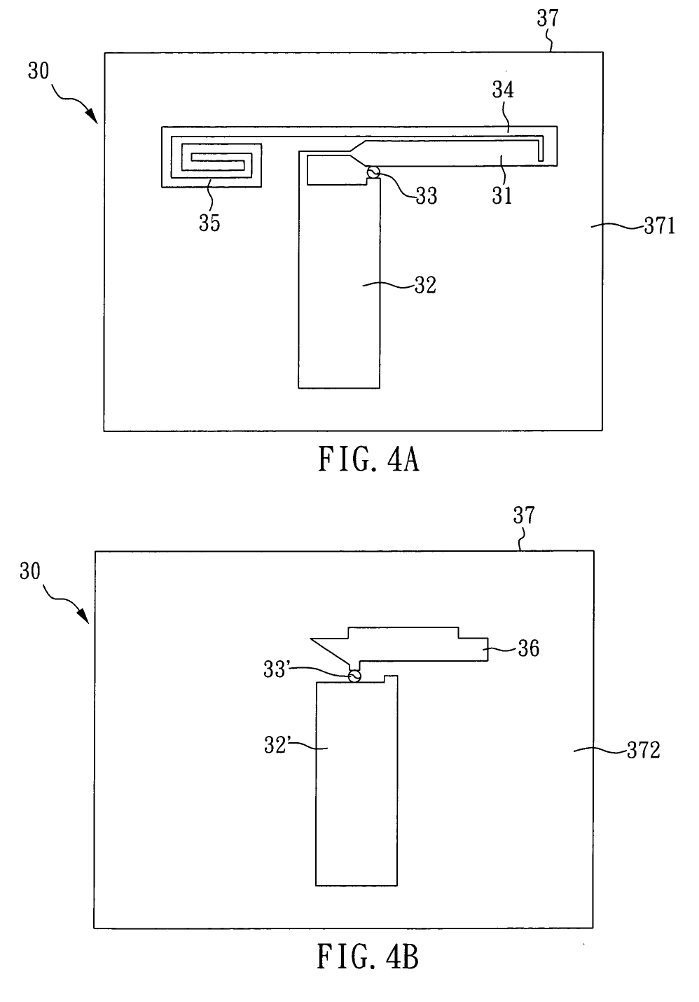

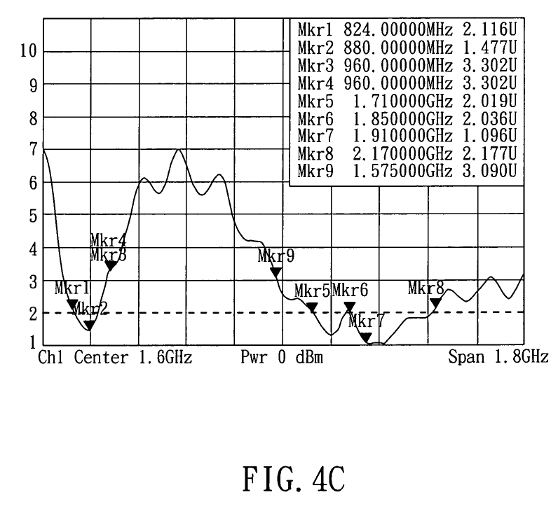

Please refer to FIG. 4A, FIG. 4B and FIG. 4C. FIG. 4A is a back view schematic drawing of a multi-frequency antenna in a third embodiment according to the invention. FIG. 4B is a front view schematic drawing of a multi-frequency antenna in the third embodiment according to the invention. FIG. 4C is a VSWR relationship drawing of the multi-frequency antenna in the third embodiment according to the invention.

As shown in FIG. 4A and FIG. 4B, the multi-frequency antenna 30 in the third embodiment comprises a first radiating element 31, grounding elements 32 and 32′, feeding structures 33 and 33′, a second radiating element 34, a top load 35, a third radiating element 36 and a base 37. The base 37 has a first surface (the back surface) 371 and a second surface (the front surface) 372. The first radiating element 31, the grounding element 32, the feeding structure 33, the second radiating element 34 and the top load 35 are disposed on the first surface (the back surface) 371 of the base 37; and the third radiating element 36, the grounding element 32′ and the feeding structure 33′ are disposed on the second surface (the front surface) 372 of the base 37. The base 37 can be a FR4 (Flame Retardant 4) standard fiber glass printed circuit board or other various design.

The difference between the third embodiment and the second embodiment is, in the third embodiment, the multi-frequency antenna 30 further has a third radiating element 36. The third radiating element 36 is disposed on the second surface (the front surface) 372 of the base 37. The third radiating element 36 and the grounding element 32 disposed on the first surface (the back surface) 371 of the base 37 are electrically connected together via the grounding element 32′; and the third radiating element 36 and the feeding structure 33 disposed on the first surface (the back surface) 371 of the base 37 are electrically connected via the feeding structure 33′. Therefore, the multi-frequency antenna 30 feeds electrical signals to the third radiating element 36 via the feeding structures 33 and 33′ by capacitive coupling, to adjust the matching of the first resonant mode and the second resonant mode to increase the bandwidth.

As shown in FIG. 4B, the third radiating element 36 is an irregular shape, or any various shape.

FIG. 4C shows a VSWR relationship drawing of the multi-frequency antenna 30 at different frequencies. Comparing FIG. 3B with FIG. 4C, the multi-frequency antenna 30 in the third embodiment utilizes the third radiating element 36 capacitive coupling effect to increase the bandwidth of the first resonant mode and the second resonant mode.

Furthermore, the multi-frequency antennas 10, 20 and 30 can be planar antennas.

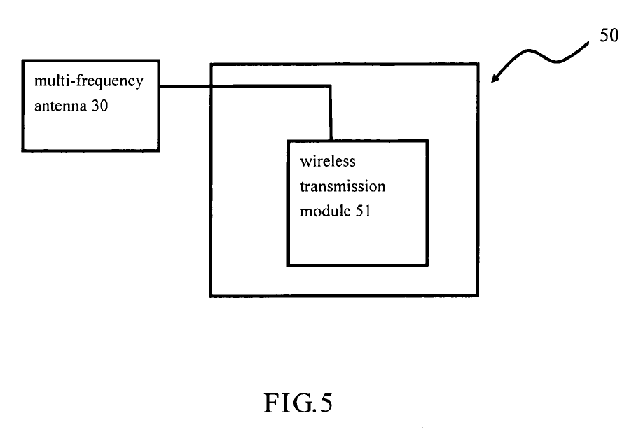

Please refer to FIG. 5, which is a functional block drawing of an electronic device according to the invention. In one embodiment of the invention, the electronic device 50 can be a cell phone, a GPS, a PDA, or a notebook computer or any other portable device. As shown in FIG. 5, an electronic device 50 comprises the multi-frequency antenna 30 and a wireless transmission module 51. The electronic device 50 utilizes RF cable (not shown) to feed into the multi-frequency antenna 30 and being electrically connected to the wireless transmission module 51, to process signals from the multi-frequency antenna 30 via the wireless transmission module 51. Afterward, the electronic device 50 utilizes the multi-frequency antenna 30 to receive or transmit wireless signals to other device (not shown).

Moreover, the electronic device 50 can also have either the multi-frequency antenna 10 or 20 to replace the multi-frequency antenna 30.

Although the present invention has been explained in relation to its preferred embodiment, it is to be understood that many other possible modifications and variations can be made without departing from the spirit and scope of the invention as hereinafter claimed.

What is claimed is:

1. A multi-frequency antenna comprising:
a first radiating element including a first end and a second end;
a grounding element connected to the first end of the first radiating element;
a feeding structure for inputting an electrical signal to the first radiating element; and
a second radiating element including a first end and a second end; the
first end of the second radiating element including a transitional portion;
and the second radiating element is connected to the second end of the first radiating element by the transitional portion;
whereby the first radiating element forms a first current path to generate a first resonant mode; and the second radiating element forms a second current path to generate a second resonant mode.

2. The multi-frequency antenna as claimed in claim 1, wherein the first radiating element and the second radiating element are integrated together.

3. The multi-frequency antenna as claimed in claim 1, wherein the transitional portion has a substantially 90° angle, the second radiating element is connected to the second end of the first radiating element via the transitional portion and extends toward to the first end of the first radiating element, so the second radiating element is substantially parallel with the first radiating element.

4. The multi-frequency antenna as claimed in claim 3, wherein a gap is formed between the first radiating element and the second radiating element.

5. The multi-frequency antenna as claimed in claim 1 further comprising a top load, the top load and the second end of the second radiating element being electrically connected together; wherein the top load is an inductive load.

6. The multi-frequency antenna as claimed in claim 5, wherein the top load is electrically connected to the second radiating element via passive component connection, circuit connection or direct connection.

7. The multi-frequency antenna as claimed in claim 5, wherein the shape of the top load is different form the shape of the second radiating element.

8. The multi-frequency antenna as claimed in claim 5, wherein the shape of the top load is a loop shape.

9. The multi-frequency antenna as claimed in claim 5 further comprising:
a base having a first surface and a second surface; the first radiating element, the grounding element, the feeding structure, the second radiating element and the top load being disposed on the first surface; and
a third radiating element disposed on the second surface and electrically connected to the grounding element; wherein the feeding structure feeds back the electrical signal to the third radiating element by capacitive coupling.

10. An electronic device capable of wireless transmission, comprising a wireless transmission module and a multi-frequency antenna, the wireless transmission module and the multi-frequency antenna being electrically connected together; the multi-frequency antenna comprising: a first radiating element including a first end and a second end; a grounding element connected to the first end of the first radiating element;
a feeding structure for inputting an electrical signal to the first radiating element; and
a second radiating element including a first end and a second end; the first end of the second radiating element including a transitional portion;
and the second radiating element is connected to the second end of the first radiating element by the transitional portion;
whereby the first radiating element forms a first current path to generate a first resonant mode; and the second radiating element forms a second current path to generate a second resonant mode.

11. The electronic device as claimed in claim 10, wherein the first radiating element and the second radiating element are integrated together.

12. The electronic device as claimed in claim 10, wherein the transitional portion has a substantially 90° angle, the second radiating element is connected to the second end of the first radiating element via the transitional portion and extends toward to the first end of the first radiating element, so the second radiating element is substantially parallel with the first radiating element.

13. The electronic device as claimed in claim 12, wherein a gap is formed between the first radiating element and the second radiating element.

14. The electronic device as claimed in claim 10 further comprising a top load, the top load and the second end of the second radiating element being electrically connected together; wherein the top load is an inductive load.

15. The electronic device as claimed in claim 14, wherein the top load is electrically connected to the second radiating element via passive component connection, circuit connection or direct connection.

16. The electronic device as claimed in claim 14, wherein the shape of the top load is different than the shape of the second radiating element.

17. The electronic device as claimed in claim 14, wherein the shape of the top load is a loop shape.

18. The electronic device as claimed in claim 14 further comprising:
a base having a first face and a second face; the first radiating element, the grounding element, the feeding structure, the second radiating element and the top load being disposed on the first face; and
a third radiating element disposed on the second face and electrically connected to the grounding element; wherein the feeding structure feeds back the electrical signal to the third radiating element by capacitive coupling.
